(19) United States
(12) Patent Application Publication
(10) Pub. No.: US 2008/0049962 A1
(43) Pub. Date: Feb. 28, 2008

(54) ACOUSTIC DEVICE HAVING ROTATABLE AUDIO OUTPUT COMPONENT

(75) Inventor: Chou-Hang Yang, Zhudong Town (TW)

Correspondence Address: SNELL & WILMER L.L.P. (Main), 400 EAST VAN BUREN, ONE ARIZONA CENTER, PHOENIX, AZ, 85004-2202, US

(73) Assignee: DARFON ELECTRONICS CORPORATION, Taoyuan (TW)

(21) Appl. No.: 11/844,537

(22) Filed: Aug. 24, 2007

(30) Foreign Application Priority Data
Aug. 25, 2006 (TW) 95131395

(51) Int. Cl. H04R 25/00

(52) U.S. Cl. 381/380

(57) ABSTRACT

An acoustic device including a body and an audio output component rotatably connected to the body is provided, in which the body is formed with a first side and the audio output component is formed with a second side. The acoustic device can selectively be in a first configuration and a second configuration by rotating the audio output component. In the first configuration, the first side is coplanar with the second side. In the second configuration, the first side and the audio output component form an included angle to allow the body lean on a user when the audio output component is inserted into an ear of the user.

### RELATED APPLICATION

This application claims the right of priority based on Taiwan Patent Application No. 095131395 entitled “ACOUSTIC DEVICE HAVING ROTATABLE AUDIO OUTPUT COMPONENT,” filed on Aug. 25, 2006, which is incorporated herein by reference and assigned to the assignee herein.

### TECHNICAL FIELD

The present invention relates to an acoustic device, and more particularly to an acoustic device having a rotatable audio output component.

### BACKGROUND OF THE INVENTION

Acoustic devices having a combination of multiple functions such as radio, recorder, and mobile phone have been commercially available in the market. In order to increase portability, the current trend for the acoustic devices is to be lighter, thinner, shorter, and smaller. FIG. 1 illustrates a conventional earphone 10, which is a kind of small acoustic device. The earphone 10 is formed with a body 11 having an audio output portion 13 projected out of the body surface 12 for inserting into the user's ear during use. One drawback of the earphone 10 is that such a projected structure of the audio output portion 13 is usually unfavorable for storage. To alleviate this drawback, the projected audio output portion 13 should be shortened as much as possible. However, the projected portion should not be too short to fit an ear or to be safely inserted into the ear without falling.

Therefore, it would be desirable to provide an improved acoustic device to resolve the problem described above.

### SUMMARY OF THE INVENTION

Accordingly, the present invention provides an acoustic device with a rotatable audio output component. When the acoustic device is in use, the audio output component is rotated to form an included angle with the body of the acoustic device, such that the audio output component can be inserted into the user's ear and allow the body to lean on the cheek of the user. When the acoustic device is not in use, the audio output component can be rotated to be coplanar with the body. Therefore, the present invention eliminates the drawback of the conventional projected structure.

One aspect of the invention is to provide an acoustic device, including a body having a first inclined plane; an audio output component having a second inclined plane opposite to the first inclined plane; and a rotation component in connection with the body and the audio output component, wherein the body and the audio output component form a first included angle through rotation, so as to allow the body to lean on a user as the audio output component is inserted into an ear of the user.

Another aspect of the present invention is to provide an acoustic device including a body having a first side and an audio output component having a second side. The audio output component is rotatably connected to the body and selectively in a first configuration and a second configuration by rotation. In the first configuration, the first side and the second side are laterally parallel; and in the second configuration, the first side forms a first included angle with the audio output component.

Still another aspect of the present invention is to provide an acoustic device, including a body having a first inclined plane and an audio output component having a second inclined plane in contact with the first inclined plane. The audio output component rotatably connects the body. The body and the audio output component form a first included angle by rotating the audio output component so as to make the body lean on a user as the audio output component is inserted into an ear of the user.

### BRIEF DESCRIPTION OF THE DRAWINGS

FIG. 1 is a diagram illustrating a conventional acoustic device.

FIG. 2 is a diagram illustrating a side view of an acoustic device in a first configuration according to one embodiment of the present invention.

FIG. 3 is a diagram illustrating a side view of an acoustic device in a second configuration according to one embodiment of the present invention.

FIGS. 4 to 6 are diagrams illustrating perspective views of an acoustic device in various configurations according to one embodiment of the present invention.

FIG. 7 is a diagram illustrating an acoustic device with an audio output component inserted into a user's ear according to one embodiment of the present invention.

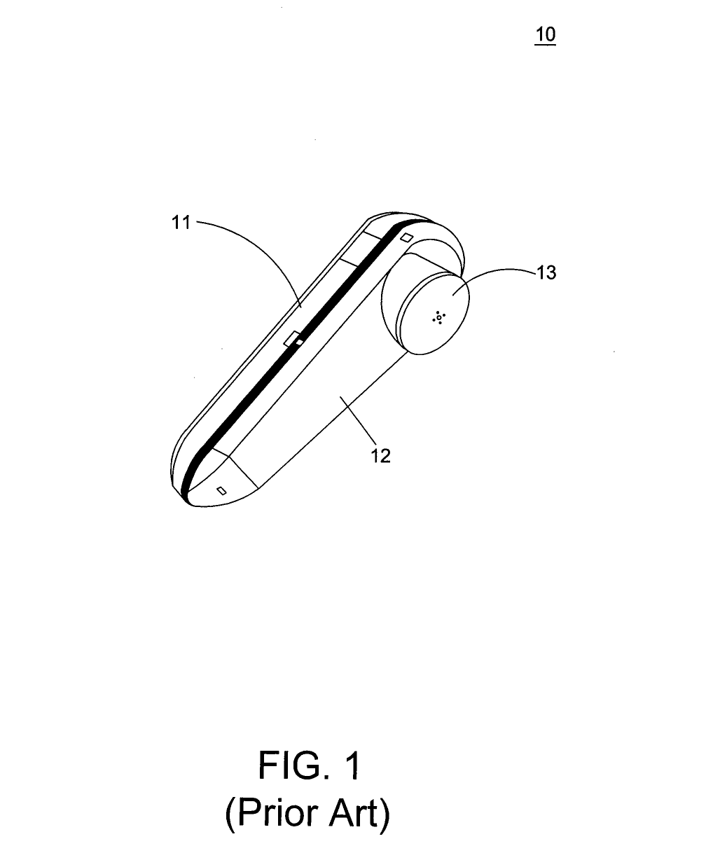

### DETAILED DESCRIPTION OF THE PREFERRED EMBODIMENTS

The preferred embodiments of the present invention will now be described in greater details by referring to the drawings that accompany the present application. It should be noted that the features illustrated in the drawings are not necessarily drawn to scale. Descriptions of well-known components, materials, and process techniques are omitted so as not to unnecessarily obscure the embodiments of the invention.

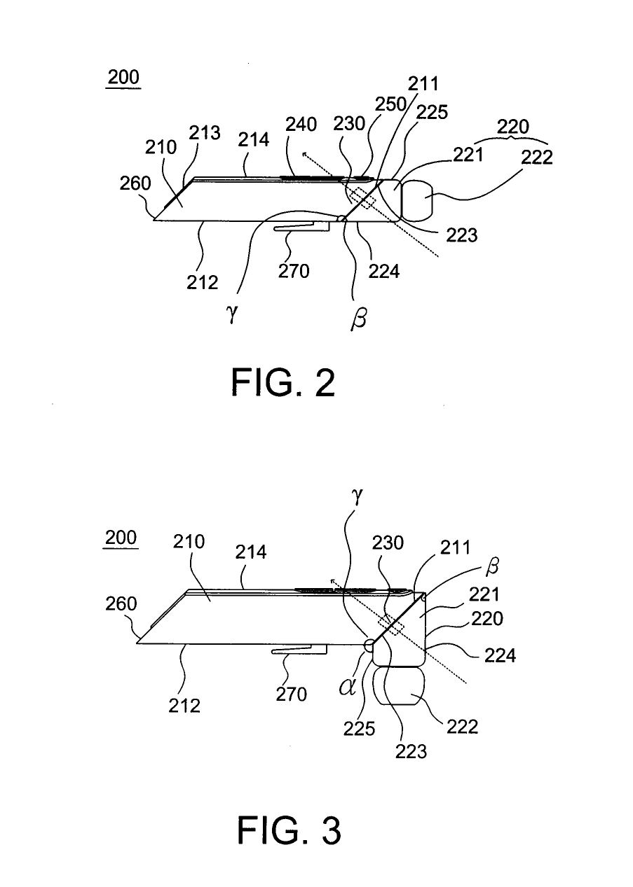

A wireless earphone is exemplarily demonstrated to be the acoustic device of the present invention. FIGS. 2 and 3 illustrate the side views of the wireless earphone 200. As shown in the figures, the wireless earphone 200 includes a body 210, an audio output component 220, a rotation component 230 for rotatably connecting with the body 210 and the audio output component 220.

Referring to FIG. 2, the body 210 is externally formed with a first inclined plane 211 and a first side 212. The first inclined plane 211 is at one end of the body 210. The audio output component 220 is formed with an earplug 222 and an extended portion 221 with a second inclined plane 223 and a second side 224. The first inclined plane 211 and the second inclined plane 223 are opposite to as well as rotatably connected with each other through the rotation component 230. Additionally, the body 210 further includes a third inclined plane 213 at the other end of the body 210 and a third side 214. The extended portion 221 further includes a fourth side 225. The third inclined plane 213 and the first inclined plane 211 are parallel and opposite; the third side 214 and the first side 212 are parallel and opposite; and the second side 224 and the fourth side 225 are parallel and opposite. More specifically, the first side 212 and the third side 214 are between the first inclined plane 211 and the third inclined plane 213.

In the exemplarily embodiment, a volume switch 240 and a power switch 250 are positioned on the third side 214 of the wireless earphone 200. The wireless earphone 200 may contain a microphone 260 disposed on the third inclined plane 213, which is convenient to the user for allowing the microphone 260 near his or her mouth during the operation of the wireless earphone 200. Yet, the wireless earphone 200 may further contain a hook 270 disposed on the first side 212, which is convenient to the user for hanging it on any appropriate place, such as the pocket of the user's shirt.

FIGS. 2 and 3 are simultaneously referred to illustrate the rotation structure of the present invention. As shown in the figures, the rotation component 230 is located at the interface between the body 210 and the audio output component 220, in which an axis of the rotation component 230 (shown as a dotted line) is perpendicular to the first inclined plane 211 and the second inclined plane 223. Note that in the embodiment, due to the feature of “inclined planes”, the corner formed by the first inclined plane 211 and the first side 212 is not orthogonal, neither is the corner formed by the second inclined plane 223 and the second side 224. Accordingly, by rotating the audio output component 220 through the rotation component 230, the wireless earphone 200 can present an L-shaped outline, in which the audio output component 220 sticks out beyond the first side 212. In other words, by means of the rotation component 230, the first inclined plane 211, as well as the second inclined plane 223, the audio output component 220 is rotatable relative to the body 210 that allows the acoustic device 200 to selectively be in a first configuration as shown in FIG. 2 (when not in use) and a second configuration as shown in FIG. 3 (when in use).

When the wireless earphone 200 is in the first configuration as shown in FIG. 2, the first side 212 and the second side 224 are laterally parallel. In the embodiment, the first side 212 is further coplanar with the second side 224 such that the wireless earphone 200 presents a pillar-shaped outline. Preferably, the wireless earphone 200 can be a pen-shaped cylinder, which is convenient for the user to hang it on any appropriate place, such as the pocket of the user's shirt as aforementioned.

When the wireless earphone 200 is in the second configuration as shown in FIG. 3, the first side 212 and the fourth side 225 form a first included angle α, which is smaller than 180 degrees. In such a configuration, the earplug 222 can be inserted into the user's ear and allow the body 210 to lean on the user's face. The first included angle α facilitates the closeness of the body 210 and the user's face. The size of the first included angle α depends upon the slope gradient of the second inclined plane 223 or the first inclined plane 211. In other words, as shown in FIG. 3, the size of the first included angle α also depends upon a second included angle β formed by the second inclined plane 223 and the second side 244, or a third included angle γ formed by the first inclined plane 211 and the first side 212. The size of the first included angle α can vary as appropriated in accordance with the desire of the skilled persons. In a preferred embodiment, the first included angle α is around 90 degrees while the second included angle β is around 45 degrees. Note that when the wireless earphone 200 is in the second configuration as shown in FIG. 3, the first included angleα is substantially twice as big as the second included angle β. Furthermore, when the audio output component 220 rotates around 180 degrees from the first configuration to the second configuration, the location of the fourth side 225 is transferred from coplanar with the third side 214 to form the first included angle α with the first side 212. The transformation of the wireless earphone 200 can also be observed from the location change of the second included angle β in FIGS. 2 and 3.

In the embodiment, the rotation component 230, indicated as dotted lines in FIGS. 2 and 3, can be entirely covered by the housings of body 210 and the audio output component 220. Since the rotation component 230 is within the body 210 and the audio output component 220, the first inclined plane 211 substantially contacts the second inclined plane 223 even when the audio output component 220 is rotated with respect to the body 210.

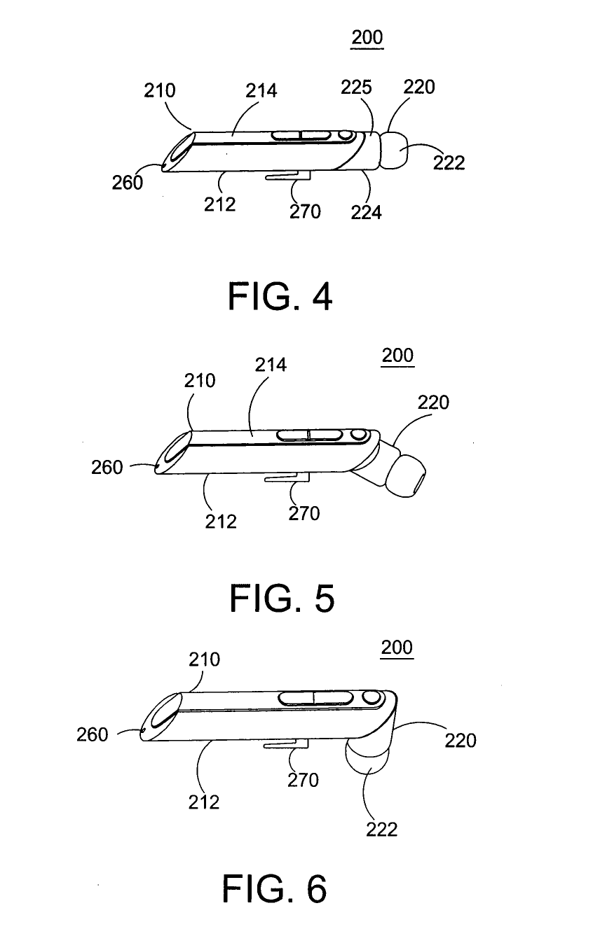

FIGS. 4 to 6 illustrate perspective views of the acoustic device 200 in various configurations. FIG.4 shows the acoustic device 200 in the first configuration, wherein the first side 212 is coplanar with the second side 224, and the third side 214 is coplanar with the fourth side 225. FIG. 5 shows the acoustic device 200 in a configuration formed by rotating the audio output component 220 around 90 degrees from the first configuration. FIG. 6 shows the acoustic device 200 in the second configuration formed by rotating the audio output component 220 around 180 degrees from the first configuration.

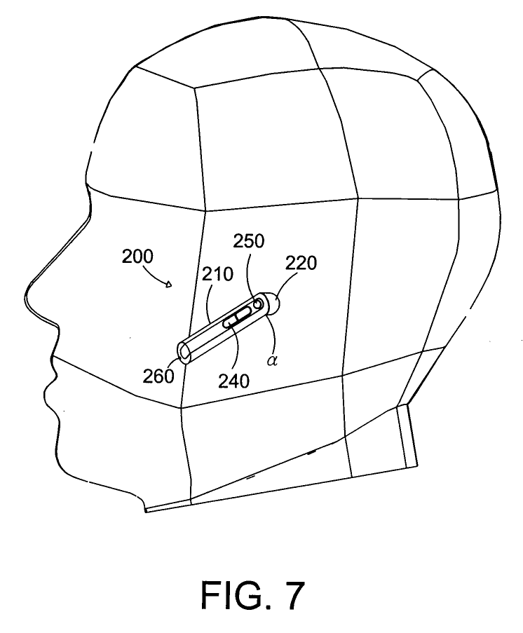

FIG. 7 shows the acoustic device 200 being in use by inserting the earplug 222 into the user's ear, in which the audio output component 220 and the body 210 form the first included angle α, i.e., in the second configuration, allowing the body 210 to lean on the user's face as aforementioned. If the acoustic device 200 is not in use, it can be transformed into a pen-shaped pillar as shown in the first configuration. Accordingly, as compared with the conventional earphone having a fixed projected audio output component, the acoustic device 200 of the present invention is apparently more advantageous in portability and appearance. Note that inserting the earplug 222 into the user's ear by turning the audio output component 220 around 180 degrees from the first configuration to the second configuration is merely a preferable demonstration. Only if it comforts the user, any degree in turning the audio output component 220 for inserting the earplug 222 into the user's ear would be appropriate and is still within the scope of the present invention.

The detailed description of the above preferable embodiments describes the technical features and spirit of the present invention, and the disclosed preferable embodiments are not intended to limit the scope of the present invention. On the contrary, the preferable embodiments and their variations or equivalents all fall within the scope of the present invention. Therefore, the scope of the present invention should be most broadly explained according to the foregoing description and includes all possible variations and equivalents.

I claim:

1. An acoustic device, comprising:
a body having a first inclined plane;
an audio output component having a second inclined plane opposite to the first inclined plane; and
a rotation component in connection with the body and the audio output component,
wherein the body and the audio output component form a first included angle through rotation to allow the body to lean on a user when the audio output component is inserted into an ear of the user.

2. The acoustic device according to claim 1, wherein an axis of the rotation component is perpendicular to the first inclined plane.

3. The acoustic device according to claim 1, wherein the body is formed with a first side, and the audio output component is formed with a second side being able to be laterally parallel with the first side by rotating the audio output component.

4. The acoustic device according to claim 3, wherein the acoustic device is pillar-shaped when the first side is laterally parallel with the second side.

5. The acoustic device according to claim 1, wherein the rotation component is covered by the body and the audio output component.

6. The acoustic device according to claim 1, wherein the acoustic device is L-shaped when the first included angle is formed.

7. The acoustic device according to claim 3, wherein the second inclined plane and the second side form a second included angle, and the first included angle is substantially twice the second included angle.

8. The acoustic device according to claim 1, wherein the first included angle is substantially 90 degrees.

9. The acoustic device according to claim 1, further comprising a hook placed on the body.

10. The acoustic device according to claim 1, wherein the first inclined plane contacts the second inclined plane.

11. The acoustic device according to claim 1, wherein the audio output component further comprises an earplug and an extended portion having the second inclined plane.

12. The acoustic device according to claim 1, wherein the rotation component connects the first inclined plane and the second inclined plane.

13. An acoustic device, comprising:
a body having a first side; and
an audio output component having a second side, rotatably connecting to the body,
wherein the body and the audio output component are selectively in a first configuration and a second figuration, in the first configuration, the first side and the second side are laterally parallel; and
in the second configuration, the first side forms a first included angle with the audio output component.

14. The acoustic device according to claim 13, wherein the audio output component rotates around 180 degrees from the first configuration to the second configuration.

15. The acoustic device according to claim 13, wherein the first side and the second side are coplanar in the first configuration.

16. An acoustic device, comprising:
a body having a first inclined plane; and
an audio output component having a second inclined plane contact with the first inclined plane, the audio output component rotatably connecting the body;
wherein the body and the audio output component form a first included angle by rotating the audio output component to allow the body to lean on a user when the audio output component is inserted into an ear of the user.

17. The acoustic device according to claim 16, wherein the body is formed with a first side, and the audio output component is formed with a second side being able to be laterally parallel with the first side by rotating the audio output component.

18. The acoustic device according to claim 16, wherein the first side and the second side are coplanar when the first side and the second side are laterally parallel.
